(19) United States
(12) Patent Application Publication
(10) Pub. No.: US 2019/0335040 A1
(43) Pub. Date: Oct. 31, 2019

(54) PRIORITIZED ROUTING DURING A REGIONAL EVENT

(71) Applicant: Microsoft Technology Licensing, LLC, Redmond, WA (US)

(72) Inventors: Russell A. Penar, Highlands Ranch, CO (US); Amer A. Hassan, Kirkland, WA (US); Ronald F. Johnson, Kirkland, WA (US)

(21) Appl. No.: 15/963,748

(22) Filed: Apr. 26, 2018

(51) Int. Cl. H04M 7/12; H04W 4/90; H04W 76/50

(52) U.S. Cl. CPC H04M 7/128; H04M 2207/12; H04W 76/50; H04W 4/90

(57) ABSTRACT

Disclosed are methods and systems for routing messages based on regional events. In some aspects, an origin of a call is determined, and a datastore consulted to determine whether the origin is experiencing a regional event. If so, an identity of the caller may be ascertained. If the caller is determined to have sufficient priority, the call may be routed over a first network. Otherwise, the call may be routed over a second network, or in some aspects, placed in a hold queue until sufficient network capacity is available to service the call.

### BACKGROUND

During regional events, such as natural disasters, power outages, major sporting events, and other events that cause disruption of ordinary daily life, the load on a computer network may vary dramatically from the usage typically experienced. For example, after a regional event, many people may attempt to contact associates and family members to discuss the event and to verify each other's safety. In contrast, other types of traffic on the computer network, such as traffic generated for commerce or business communications, may be reduced dramatically during these events.

Network operators may be challenged during these regional events to maintain nominal network communication for users under the very dynamic load conditions that may be experienced. In some cases, network communication may be interrupted due to the changing nature of the workload. For example, in some scenarios, portions of a network may become overloaded due to a localized increase in traffic caused by the regional event. This interruption in network service can impair the ability of the community served by the network to take appropriate measures to mitigate effects of the regional event. For example, if first responders seek to use the network to coordinate a response, this coordination may be difficult or impossible if network communications are disrupted. Therefore, improved methods of managing network communication during regional events are desired.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an overview diagram of an example communication system that may be implemented in at least some of the disclosed embodiments.

FIG. 2 is an overview diagram showing one example of how the event aggregator may provide information on a regional event.

FIG. 3 shows one example relational design of the event datastore.

FIG. 4 shows one example relational design of a caller ID datastore.

FIG. 5 shows one example format of a call request.

FIG. 6 is a flowchart of an example method for routing a call request message.

FIG. 7 is a flowchart of an example method for determining a priority of a call request message.

FIG. 8 is a flowchart of an example method for determining an identity of a caller for a call request.

FIG. 9 illustrates a block diagram of an example machine upon which any one or more of the techniques (e.g., methodologies) discussed herein may perform.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, regional events may cause substantial changes in usage requirements and patterns than those typically experienced by a computer network. When the computer network is providing telephony services, the changes can be particularly acute, as people frequently reach for their telephones as a primary means of communication, especially during times of stress or urgency. These changes in usage demands on a computer network may, in some cases, prevent the computer network from accommodating all requests for service. For example, a surge in telephony call requests during a regional event may occupy all available circuits on a circuit switched network, or may fully utilize the compute and/or and buffering capacity and/or transmission throughout of a packet switched network. Thus, network providers are faced with a technical problem of how to service requests for network communications during a time when available network capacity may be insufficient to service all of the requests for communication, while ensuring that those requests for communication that are truly important, such as those of first responders, are still able to experience successful communications using the computer network.

To solve these technical problems, the disclosed embodiments implement a technical solution including identifying whether a received call request originates from a region experiencing a regional event. First, the disclosed embodiments may establish or determine a region from which the call originates. In some aspects, caller ID technologies may be used to isolate a location of a land based phone of a caller. For example, a telephone number, provided by caller ID, may be mapped to an address based on a telephone directory, which may be obtained from a variety of commercial providers. In some other embodiments, 911 based technologies, such as the “phase 2” requirements, may be utilized to obtain location information. In some aspects, a mobile handset making a phone call may include a client application, such as a digital telephony application, that interfaces with a GPS device of the mobile handset to provide location information in the call request itself, or make it available when queried by network components that are completing the call.

Once a geographic location of the caller is established, some embodiments may determine whether that location is experiencing a regional event. In some aspects, this is accomplished by maintaining a regional event datastore. The regional event datastore may be populated by data obtained from a number of data sources, including both governmentally controlled web services and/or web sites, and or private information sources. The disclosed embodiments may also actively mine information from news and social networking sites, such as Facebook, Google, ABCnews, Cable News Network (CNN), and other information sources to obtain information relating to regional events.

If the system determines that a geographic region from which a call request originates is experiencing some type of regional event, an identity of the caller may be obtained. In some aspects, the identity of the caller may be obtained based on caller ID information included in the call request. Some of the disclosed aspects maintain a datastore that maps caller id information, such as phone numbers, to caller identities. Some aspects further maintain a datastore mapping these caller identities to call priorities. For example, during a regional event, calls from police, fire, and other first responders may be given priority over other callers. Similarly, calls from politicians, such as mayors, city council members, or others may also be given priority. Other people who may not have any larger role in managing the regional event, may be given a lower priority to provide adequate network capacity to handle those particular individuals who's calls must be serviced.

In some cases, an identity of a caller may not be obtained from the telephony call request message itself. In these cases, some embodiments may forward these calls to either an interactive voice response system, or in some cases, to a human operator based hold queue. Using one or more of these systems, an identity of the caller may be ascertained. Once the identity of the caller is discovered via the IVR system or the human operation, this identity information may be stored for future use, and then also used to determine how best to route the call of the identified caller. Thus, by determining a status of a call's origin, and then ascertaining an identify of the caller, from which an appropriate prioritization of the call request can be made, the disclosed embodiments provide a solution to the technical problem described above.

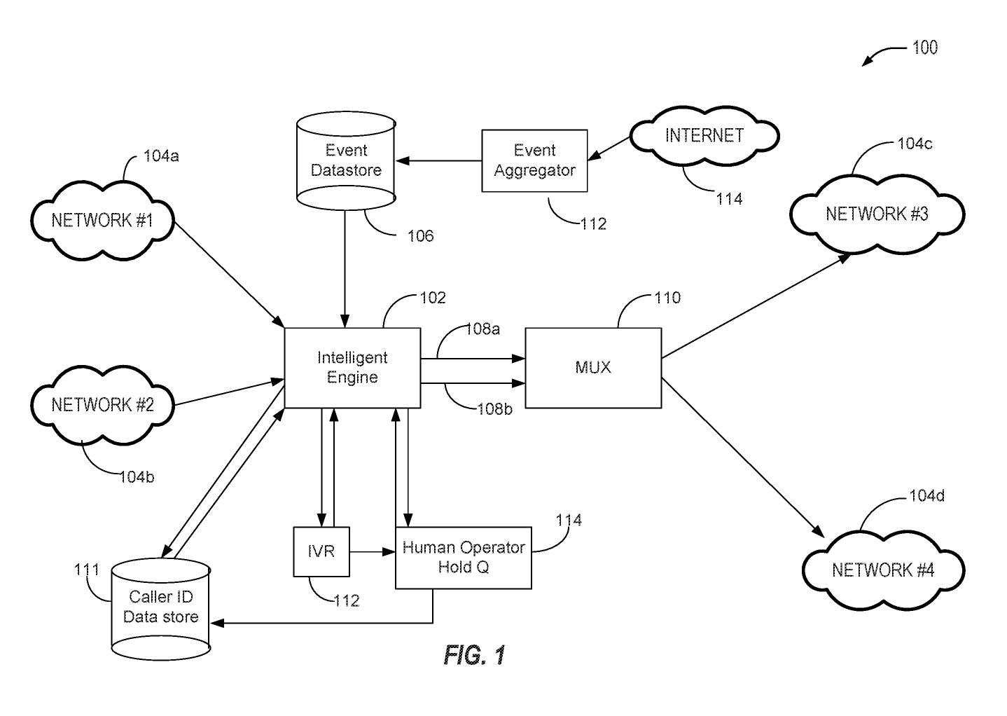

FIG. 1 is an overview diagram of an example communication system that may be implemented in at least some of the disclosed embodiments. FIG. 1 shows a communications system 100 including an intelligent engine 102. The intelligent engine 102 may receive telephony calls from at least a first network 104a and a second network 104b. The telephony calls may be received in the form of telephony call request messages. For example, in some aspects, network messages encoding voice over internet protocol (VoIP) calls, session initiation protocol (SIP) call requests, IP Private Branch Exchange (IP PBX) call request messages, or other forms of call request messages may be received by the intelligent engine 102. In addition, after a call is established, the intelligent engine 102 may also receive call data from any of the networks 104a-d. For example, data generated when a caller speaks may be transmitted in FIG. 1 from left to right, where the data originates in one of networks 104a-b and is transmitted to one of networks 104c-d. When the callee speaks, data may be generated within one of the networks 104c-d and pass through the intelligent engine 102 on its way to one of the networks 104a-b.

The intelligent engine 102 may also receive information regarding regional events from an event datastore 106. The intelligent engine 102 may utilize information from the event datastore 106 to determine routing for telephony calls received from either the first network 104a or the second network 104b. Once routing for an incoming call from either the first network 104a or the second network 104b is determined, the intelligent engine 102 may transmit data signals 108a and control signals 108b to a multiplexer 110. The multiplexer may control routing of calls represented by the data signals 108a over either a third network 104c or a fourth network 104d. In some aspects, the multiplexer 110 may be implemented via a domain name system (not shown). For example, in some aspects, the intelligent engine 102 may set particular destination hostnames to use particular IP addresses that may cause routing of calls for that particular destination hostname to be carried over a particular network, such as one of networks 104c or 104d.

The event datastore 106 may be populated by an event aggregator 112. In some aspects, the event aggregator 112 may obtain data from the Internet 114. For example, the event aggregator 112 may query one or more websites or web services to obtain information on events that may be occurring within one or more geographic regions. For example, the event aggregator 112 may obtain one or more of information indicating seismic activity, information indicating weather activity, information indicating police activity, information indicating criminal activity or the like from one or more web services and/or web sites on the internet. The event aggregator may then parse this information to extract information relevant to the system 100 and store the information in the event datastore 106. For example, by parsing information from, for example, an United States Geological Survey web site, the event aggregator 112 may determine whether particular geographic region(s) have experienced an earthquake in a previous predetermined time period. By parsing this received information, the event aggregator 112 may, in some aspects, determine a size of the earthquake on the Richter scale. In some aspects, the event aggregator 112 may compare the size to a threshold, and thus determine whether a geographic location indicated by the information is experiencing a regional event based on the comparison. This indication may then be written to the event datastore 106 in some aspects.

In some aspects, weather data may be downloaded by the event aggregator, for example, in some aspects, from a governmental web site or web service, such as that offered by the United States national weather service (www.weather.gov). Weather data for a variety of locations, including origins of telephony call request messages processed by embodiments of this disclosure, may be obtained by downloading this information from these web sites and/or web services. The data may then be parsed and recorded in the event datastore 106 in some aspects. In some aspects, the weather data may indicate wind speed in one or more geographic regions. In some aspects, the event aggregator 112 may compare the indicated wind speed in a region to a wind speed threshold, and record an indication of whether the region is experiencing an event based on whether the wind speed is above or below the threshold for example.

The intelligent engine 102 may also interface with a caller id datastore 111, an interactive voice response system 112, and/or a human operator based hold queue 114. In some of the disclosed aspects, an identity of a caller may play a role in how that call is routed. For example, in cases of regional emergencies, calls from first responders, elected officials, or other VIPs may receive priority routing. Thus, in some cases, calls identified as being from an individual with a high priority may be routed over a first network, while other calls may be routed over a second network. In some aspects, the first network may be reserved for calls designated as high priority. In these aspects, lower priority calls may not be routed over the first network, regardless of a utilization of the first network. This may ensure adequate capacity on the first network to successfully complete these high priority calls. In some other aspects, at least some lower priority calls may also be allowed or routed over the first network. For example, in some aspects, if a utilization of the first network meets particular utilization criteria, then lower priority calls may be routed over the first network. As one example, if the utilization is below a certain threshold level such that routing some lower priority calls over the first network does not jeopardize placing a high priority call when needed, then lower priority calls may also be routed over the first network. When the utilization reaches a certain defined threshold however, these aspects may stop routing lower priority calls over the first network, reserving remaining capacity on the first network to higher priority calls only.

In some aspects, the intelligent engine 102 may consult the caller id datastore 111 to determine an identify of a caller based on caller identification information included in a telephony call request message. In some cases, the intelligent engine 102 may interface with a calling handset (not shown) to obtain caller id information not readily available in the call request message itself. The caller id datastore 111 may include information that provides the intelligent engine 102 with information as to a caller's identity and also information relating to a priority of the caller.

In some aspects, the intelligent engine 102 may be unable to obtain an identify of the caller based on caller information included in a telephony call request message. For example, the call request message may not include any caller id information, or there may not be any caller identification information for a callee number in the caller id datastore 111. In these cases, some embodiments may direct the call to either an interactive voice response system 112 and/or a human operator based hold queue 114. In some aspects, by asking the caller a series of questions, the caller's identity may be obtained interactively via the IVR system 112. In some aspects, if the IVR system 112 is unable to verify an identity of a caller, the IVR system 112 may transfer the call to the human operator hold queue 114, which may connect the caller with a human operator to obtain more information on the caller's identity. In some cases, after the human operator verifies the caller's identity, that information may be provided to the caller ID datastore 111. This additional information may assist in making the caller id datastore 111 more comprehensive, and may prevent a caller from being directed to the human operator hold queue for multiple calls made during a regional event.

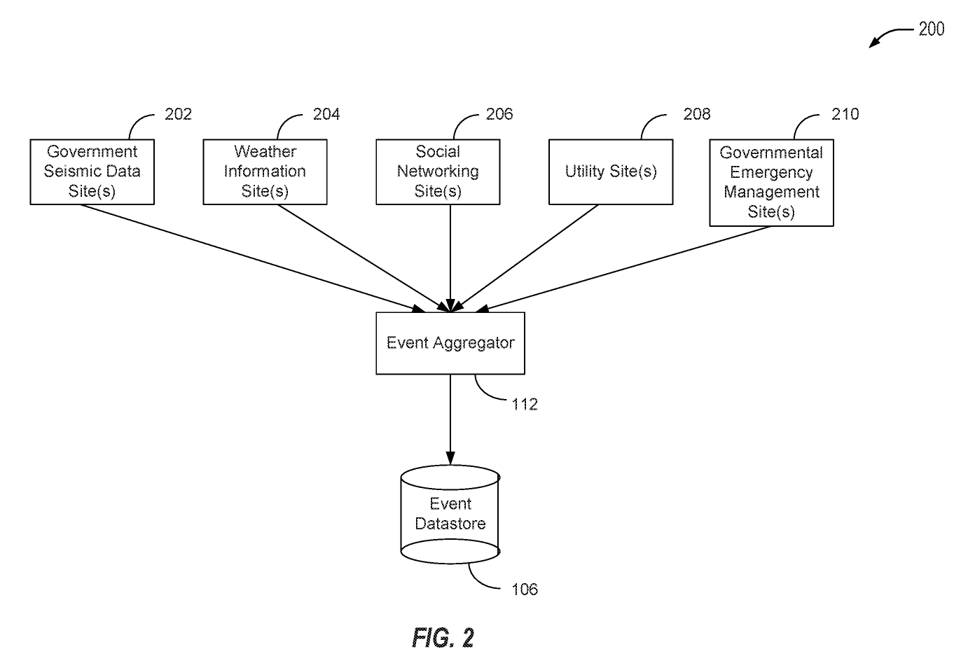

FIG. 2 is an overview diagram showing one example of how the event aggregator may provide information on a regional event. FIG. 2 shows that the event aggregator 112 may obtain information from one or more of government seismic data site(s) 202, weather information site(s) 204, social networking site(s) 206, utility site(s) 208 (such as water, electric, natural gas), and government emergency management site(s) 210. The event aggregator 112 may obtain information relating to regional events from these site(s) and store the information in the event datastore 106. The event datastore 106 may then be consulted by the intelligent engine 102, discussed above with respect to FIG. 1, when determining how to route telephony call request messages over a plurality of networks. Event aggregator 112 may obtain this information by utilizing an Application Programming Interface of these sites and/or scraping these sites from one or more public facing webpages.

The governmental seismic data site(s) 202 may include, for example, sites maintained by the U.S. Geological Survey (e.g. www.earthquake.usgs.gov). Weather information may be obtained from the national weather service in some embodiments (e.g. www.weather.gov). The event aggregator may obtain information from social networking sites such as Facebook, Snapchat, LinkedIn, or other sites. Public utility information sites may also be mined in some aspects to obtain information on utility outages. For example, in some aspects, the Tennessee Valley Authority's website may be mined for outage information (e.g. www.tva.gov). In some aspects, governmental emergency management sites may be mined for information by the event aggregator 112. For example, in some aspects, the federal emergency management administrator may be consulted (e.g. www.fema.gov).

Some web data may explicitly define an event. For example, governmental emergency management sites, such as those that provide earthquake data, may explicitly define in the data whether a serious earthquake has occurred. Upon downloading and parsing this data, the event aggregator may recognize events as defined in the downloaded data and write information indicating the event (discussed in more detail below) to the event datastore 106. Some other web resources may not explicitly define events. For example, social networking activity, such as that generated by social networking sites 206, may not explicitly define events. For these types of websites, the event aggregator 112 may apply one or more heuristics and/or machine learning to generate events based on the data generated by the social networking sites 206 and downloaded by the event aggregator 112. For example, in some aspects, the event aggregator may scan social networking data downloaded from social networking site(s) 206 for certain keywords that may relate to an event. For example, keywords such as “tornado” appearing in proximity to other keywords indicating a geographic location, (e.g. “tornado” and “Ft. Wayne, Indiana”) might cause the event aggregator to generate a tornado event in the geographic region corresponding to Fort Wayne, Ind. In some aspects, a threshold count on the number of social media postings meeting a criteria (within a threshold period of time) may also be applied before an event is recognized. This may help prevent false positives. For example, if fewer than a threshold number of events within a defined time period meet one or more defined criterion for a particular type of event, the event may not be recognized, detected, or otherwise used to affect routing decisions of the disclosed embodiments. If the number of vents meeting the one or more criterion within the defined time period exceed, then the event may be recognized, and may, in some aspects, change routing decisions made by the disclosed embodiments.

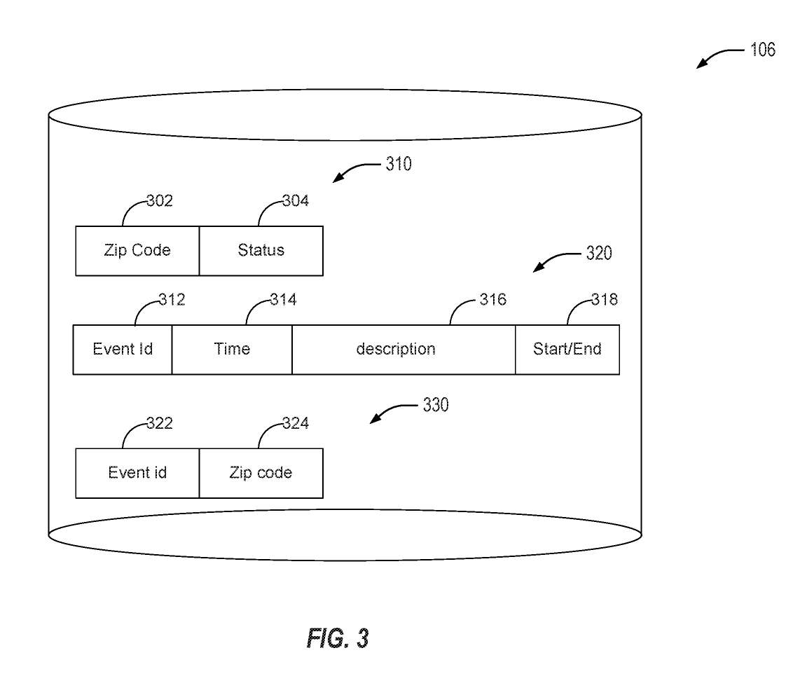

FIG. 3 shows an example relational design of the event datastore 106. FIG. 3 shows a relational implementation of the event datastore 106. The relational implementation of the event datastore 106 includes at least three tables; a zip code status table 310, an event description table 320, and an event location table 330. The event description table 320 may include at least one row for every event identified by the event aggregator 112. The event description table 320 includes an event id 312, a time relevant to the event 314, a description of the event 316, and a start/end indicator 318. The event id column 312 may uniquely identify a single event. The time column 314 may indicate a time that the information in the row of the event description table 320 was obtained. Alternatively, the time column 314 may indicate a start or end time of an event identified by the event id. The description column 316 may provide a text description of the event, or a text description relevant to the event at the time indicated by the time field 314. For example, if the time column 314 indicates a start time of the event, the description table 316 may describe the nature of the event. If the time column 314 indicates an end time of the event, the description column 316 may indicate the event has ended. The start/end field 318 may indicate whether the particular row of the event description table 320 indicates a start or an end of the event. By scanning the event description table 320, it may be possible to determine whether an event is in progress or has been completed based on all of the start/end fields 318 for a particular event.

The event location table 330 includes an event id field 312, which may correspond to an event identifier stored in the event id column 312, and a zip code column 324. An entry or row of the event location table 330 indicates the event identified by the event id 322 is occurring or did occur in the zip code indicated by zip code field 324.

The zip code status table 310 includes a zip code 302 and a status 304. The zip code status table 310 provides event status for zip codes 302 stored in the zip code status table 310. In some aspects, the event aggregator 112 may parse information in the event description table 320 and the event location table 330 to determine a status 304 for a zip code 302. For example, the event aggregator 112 may parse the event description table 320 to determine whether an event is active or has ended, and store that information in the status field 304.

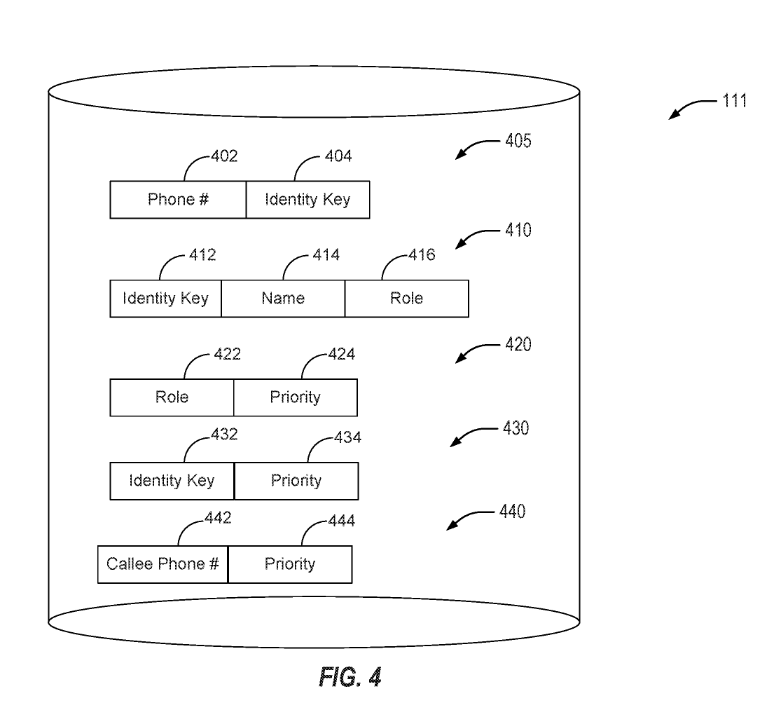

FIG. 4 shows one embodiment of a caller ID datastore 111. The illustrated embodiment of the caller id datastore 111 may include a phone number table 405, identity table 410, a role table 420, an override table 430, and a callee phone number table 440. The phone number table 405 includes a phone number column 402 and an identity key 404. The identity key 404 uniquely identifies an individual. An entry in the phone number table 405 indicates the system 100 has established an identity for a particular phone number stored in the phone # field 402. In some aspects, multiple phone numbers may map to a single identity, for example, via multiple “rows” or entries in the phone number table 405 for the same phone # value in phone number field 402. The identity table 410 stores a mapping between the identity key 412 (equivalent to the identity key value stored in the identify key column 404), a name field 414, and a role field 416. The name field 414 stores a name associated with an individual identified by the identity key 412. The role field 416 stores a role for the identified individual. For example, the role column 416 may identify whether the individual is a police officer, fire fighter, or private citizen. The role table 420 includes a role field 422 and a priority field 424. The role field 422 may store a value also found in some of the role fields 416. An entry in the role table 420 defines a priority for individuals having a particular role. Thus, for example, the role table 420 may indicate a policeman has a first priority, while a mayor has a second priority. The override table 430 provides for an individual's priority to be different than the priority defined by their role. Thus, for example, if a particular policeman should have a higher priority for some reason than most other policeman, the override table 430 may be used to specifically indicate a priority of a particular individual. The override table 430 includes an identity key field 432 and a priority field 434, defining the priority for an individual identified by the identity key 432. The caller phone number table 440 provides a mapping between callee phone numbers 442 and a priority 444. In some aspects, the callee phone number table 440 may be used to prioritize calls to certain destinations or callees. For example, some aspects may prioritize calls to one or more of police, fire, elected officials, particular city services, public utilities, or other important organizations or individuals during a regional event.

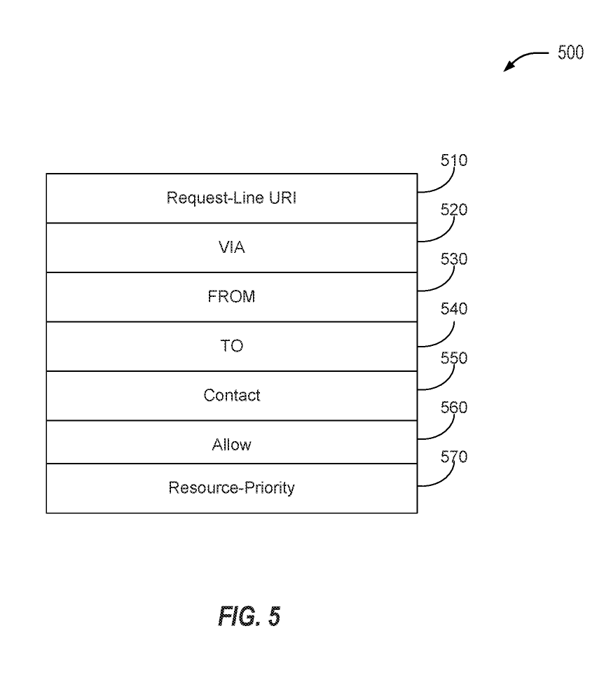

FIG. 5 shows one example format of a telephony call request message. The example telephony call request message 500 is a session initiation protocol (SIP) call request. The telephony call request 500 includes a request line URI 510, a via field 520, a from field 530, a to field 540, a contact field 550, an allow field 560, and a resource-priority field 570. The request-line URI field 510 identifies a destination of a call. The via field 520 defines an accumulating list of hops as the call request 500 moves through a network. For example, each proxy in a call path adds to a top of the “Via” field, an address and port on which it received the call request 500. When a call response is processed, each proxy in the return path processes contents of the via field 520 in reverse order, while also removing its own address from the top. The from field 530 indicates an identity of an initiator of the request. The from field 530 may include a URI and optionally may include a display name. The from field 530 may be used to determine which processing rules to apply to a request.

The to field 540 indicates a logical recipient of the request 500, or an address of record of a user or resource that is a target of the request. The to field 540 may include a SIP URI, but other addressing methods are contemplated. The contact field 550 indicates a SIP URI that may be used to contact a sender of the call request 500. The allow field 560 provides, in a comma separated format, SIP methods that a caller supports. SIP defines the following methods: ACK, BYE, CANCEL, INFO, INVITE, NOTIFY, OPTIONS, PRACK, REFER, REGISTER, SUBSCRIBE, UPDATE. The resource-priority header 570 may indicate priority information for the call request. In some aspects, the resource-priority header 570 may include a resource-value field (not shown), a namespace field (not shown), and a priority field (not shown). In some aspects, the priority field may indicate a priority of the call request 500. Some of the disclosed embodiments may route the telephony call request message shown in FIG. 5 based on one or more regional events, in accordance with this disclosure. For example, in some aspects, the intelligent engine 102 may route the call request based on the resource-priority header 570. In some aspects, caller identification information included in the call request message 500, or accessible based on one or fields of the call request message 500, may determine an identity of the caller and prioritize the call request based on the identity. In some aspects, aspects of the disclosed embodiments may prioritize routing of the call request message 500 based on information in the to field 540. For example, in some aspects, calls to police, fire, or other emergency services may receive enhanced priority by the disclosed embodiments, such that, for example, calls to particular types of callees are given higher priority than calls to other type of callees. As such, calls to the particular types of callees may be routed over a first network while calls to other types of callees may be routed over a second network.

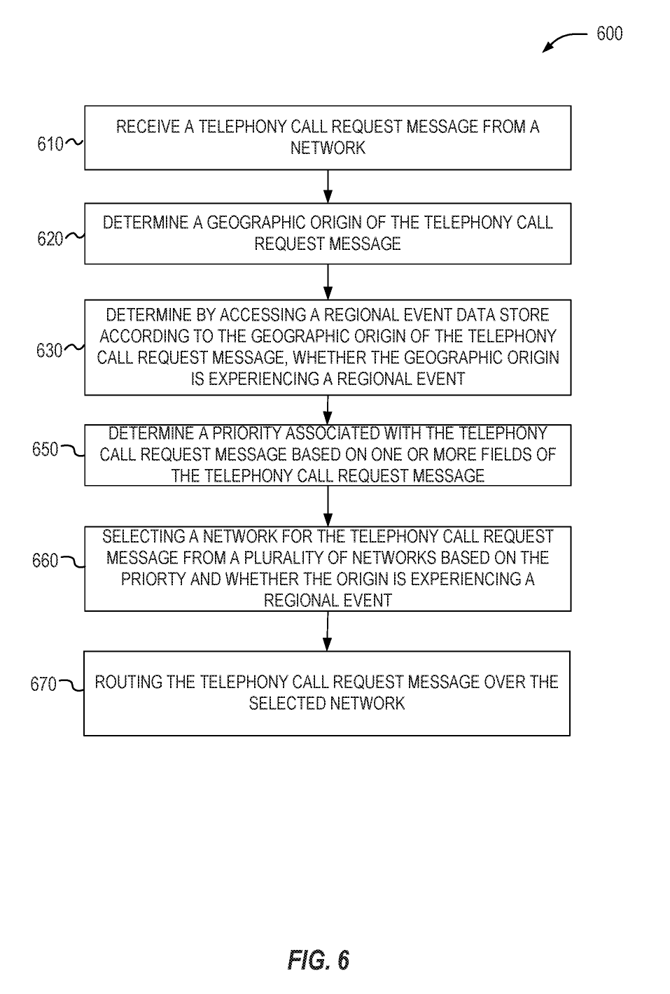

FIG. 6 is a flowchart of an example method for routing a telephony call request. In some aspects, one or more of the functions discussed below with respect to process 600 and FIG. 6 may be performed by the intelligent engine 102. For example, instructions stored in a memory of the intelligent engine 102 may configure processing circuitry of the intelligent engine 102 to perform one or more of the functions discussed below with respect to FIG. 6.

In block 610, a telephony call request message is received from a network. For example, in some aspects, the intelligent engine 102 may receive a telephony call request from either the network 104a or the network 104b. In some aspects, the telephony call request message may be of a format including one or more of the fields of the example telephony call request message format 500, discussed above with respect to FIG. 5. In other aspects, the telephony call request message may be a VoIP call request, IP PBX call request, or any other type of telephony call request message. In some other aspects, the message may be a call data message. In other words, after a call is established, block 610 may receive a message including data for the call itself.

Block 620 determines a geographic origin of the telephony call request message received in block 610. In some aspects, the geographic origin may be obtained by mapping a source caller phone number to a geographic origin. In some aspects, block 620 may obtain caller id information from the telephony call request message, and map the caller id information to a location based on a datastore. The datastore may indicate the mapping. For example, as discussed above, phone directories are commercially available that provide at least a partial mapping of phone numbers to addresses. When a telephony call request message originates from a land-based phone handset (as opposed to a mobile handset), the phone directory may be an effective mechanism to obtain a geographic origin of the call. In some other aspects, block 620 may utilize call location technologies to identify a location of a caller. For example, in some aspects, “phase 2” call location technologies may be utilized. In some aspects, SIM-based technologies may be utilized. For example, a subscriber identity module (SIM) in GSM and Universal Mobile Telecommunications System (UMTS) handsets may provide an ability to obtain raw radio measurements from a handset. These measurements may include a serving cell tower identifier, round-trip time, and signal strength. This information may be used to identify an approximate location of a caller. In some aspects, block 620 includes transmitting a message to a calling device that initiated the telephony call request message. The message may request coordinates of a geographic location of the calling device. Block 620 may include receiving a response from the calling device, and parsing the response to determine the geographic origin of the call. In some aspects, the geographic origin may be mapped to a zip code. In some aspects, the geographic origin may be mapped to geodetic coordinates on the earth.

Block 630 determines whether the geographic origin identified in block 620 is experiencing a regional event. As discussed above, in some aspects, this may be determined by accessing an event datastore (e.g. 106). For example, in aspects that map, in block 620, the geographic origin of the call request to a zip code, the event datastore 106 may be structured in a similar manner to that described above with respect to the example event datastore 106 of FIG. 3. Thus, in some aspects, the zip code status table 310 (and specifically the status field 304) may be consulted in some aspects to determine whether the geographic origin determined in block 620 is experiencing a regional event.

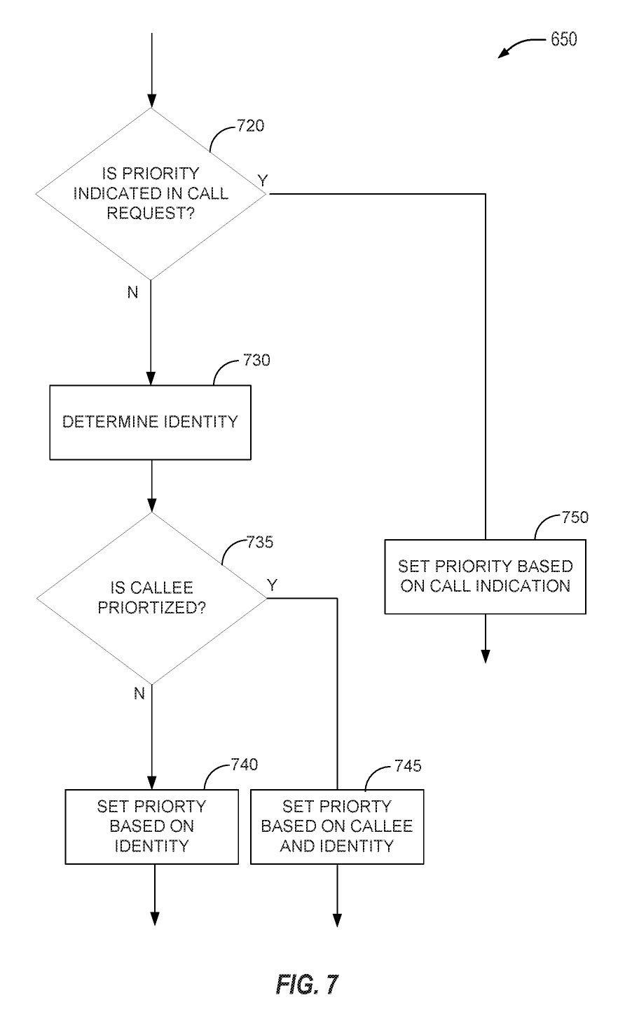

In block 650, a priority associated with the telephony call request message is determined. In some aspects, the priority may be based on one or more fields of the telephony call request message. For example, in some aspects, block 650 may search for a resource priority field (e.g. 570) in the call request message (e.g. 500). The discussion of FIG. 7 below provides further detail on how the priority may be determined in various aspects.

In block 660, a network is selected for the telephony call request message from a plurality of networks based on the priority and whether the origin is experiencing a regional event. For example, as discussed above, in some aspects, the intelligent engine 102 may select either the network 104c or 104d for a call request message. In some aspects, this selection may be based on the priority determined in block 650. For example, one of the networks 104c-d may be designated for network traffic and/or telephony calls from one or more regions experiencing a regional event. In some aspects, a different network may be designated for calls from origins not experiencing one or more regional events. In some aspects, a particular network may be generally operated at a relatively low utilization, for example, a defined percentage below its maximum capacity, so as to reserve capacity for geographic origins experiencing regional events. When a regional event is detected, calls originating from the region may be routed over this particular network, thus ensuring adequate capacity.

In block 670, the telephony call request message is routed over the selected network. In some aspects, to route the call request message over the selected network, the intelligent engine 102 may transmit the message and one or more control signals to a multiplexor (e.g. 110). The control signals (e.g. 108b may indicate a destination network (e.g. 104c or 104d) for the telephony call request.

Some aspects of process 600 include detecting a regional event has ended. For example, as discussed above, the event aggregator may iteratively search one or more internet resources for information on regional events. This process may detect not only a beginning of a regional event, but also an end point of a regional event. For example, a governmental entity may publish information indicating when weather conditions have fallen below a threshold for a weather event, such as a hurricane or a tropical storm warning. Detection of this indication by the event aggregator may cause the event aggregator to write an entry to a datastore (e.g. 106) indicating the event has ended (e.g. an entry in the event description table 320 with an end indication in the start/end field/column 318). In some aspects, in order for an event to be considered current, a certain number of indications of the event may be detected during a defined period of time. For example, in some aspects, if a rate of new social media postings meeting criterion indicating an event persists above a defined threshold level, the event is considered ongoing or active, and may affect how the disclosed embodiments route call request messages. If the rate of new social media postings meeting the criterion falls below the defined threshold level, the event may be considered terminated. In these aspects, an additional row or entry may be made in the event description table 320, including a start/end marker 318 indicating the event is ended. The intelligent engine 102 may periodically fetch information from the event datastore 106, and thus detect when the regional event has ended.

In some aspects, process 600 may include routing calls from other geographic origins, that are not experiencing a regional event, to a network other than the selected network. In this way, traffic on the selected network may gradually decrease, as most call traffic is routed over other networks, allowing the selected network to focus on delivering network communication services for one or more regions experiencing a regional event.

FIG. 7 is a flowchart of an example method for determining a priority of a caller. In some aspects, one or more of the functions discussed below with respect to process 650 of FIG. 7 may be performed by the intelligent engine 102. For example, in some aspects, a hardware memory of the intelligent engine 102 may store instructions that configure processing circuitry of the intelligent engine 102 to perform one or more of the functions discussed below. In some aspects, block 650 of FIG. 6 may include one or more of the functions discussed below with respect to FIG. 7.

Block 720 checks to determine whether a priority is indicated in the call request. In some aspects, block 720 may search the call request message for a resource-priority header field (e.g. 570). The resource-priority header field may convey a resource priority in a session initiation protocol (SIP) call request. If the priority is indicated in the call request, a priority of the call is determined based on the indicated priority in block 750. Otherwise, process 650 moves to block 730, which determines an identity of the caller. After the identity is determined in block 730, process 650 moves to decision block 735, which determines if the callee is prioritized. For example, some aspects of block 735 may search the callee phone number table 440, discussed above with respect to FIG. 4. The callee phone number may be determined by the call request message (e.g. to field 540 in some aspects). If an entry for the callee phone number is stored in the callee phone number table 440, then block 735 may determine that the callee is prioritized. For example, the call may be to police, fire, or other relatively important callers, for which calls should be prioritized during a regional event. If the callee is prioritized, process 650 moves to block 745, which sets the calls priority based on the callee priority (e.g. 444) and the identity (e.g. 412). Otherwise, process 650 moves from block 735 to block 740, which prioritizes the call based on the identity.

In block 740, the priority of the call request is determined based on the identity. For example, in some aspects, block 740 may determine a role of the caller based on the caller id datastore 111, discussed above with respect to FIGS. 1 and 4. For example, in some aspects, a role (e.g. 416) of the caller may be obtained from the identity table 410 (e.g. via the identity key 412). A priority (e.g. 424) may then be obtained from the role table 420 based on the role (e.g. 422). In some other aspects, the override table 430 may include a mapping from the identity (e.g. 432) to a priority (e.g. 434). Note some aspects of process 650 may not rely on a priority indication included in the call request message itself. In these aspects, block 720 and 750 may not be performed.

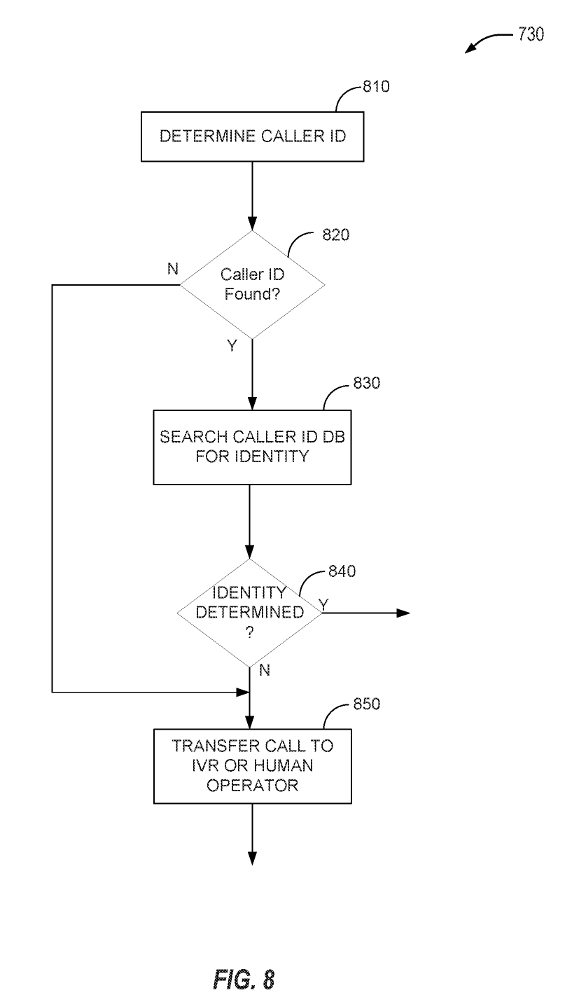

FIG. 8 is a flowchart of an example method for determining an identity of a caller. In some aspects, one or more of the functions discussed below with respect to FIG. 8 and process 730 may be performed by the intelligent engine 102. For example, a hardware memory included in the intelligent engine 102 may store instructions that configure processing circuitry of the intelligent engine 102 to perform one or more of the functions discussed below

In block 810, a caller identification of a call request is determined. In some aspects, the call request may be a telephony call request, such as a call request received by the intelligent engine 102 from one of the networks 104a or 104b. In some aspects, if the call request is a session initiation call request, such as a SIP invite message, caller id information may be included in the “From” SIP header (e.g. 530). In some aspects, the caller's number may be included in a user field of a SIP URL, or appear in a “tel:” URL. In some other aspects, 911 “Phase 2” technology may be utilized to determine the caller identification.

Decision block 820 determines whether caller identification information was obtained in block 810. If no caller id information was found, process 730 moves to block 850, discussed below, otherwise, process 730 moves to block 830, which searches a caller id datastore for identity information. For example, block 830 may rely on a stored mapping between caller id information (such as a phone number and/or name) and an identity. As discussed above with respect to FIG. 4, some aspects, may maintain a caller id datastore 111. In some aspects, based on a phone number (e.g. 402) obtained from caller id information, identity information (e.g. 404) may be obtained. The identity information (e.g. 412) may be used to obtain more information on an identity of the caller (e.g. 414) and a role of the caller (e.g. 416). In some aspects, the role information (e.g. 422) may be used to determine a priority of the call (e.g. 424). Some aspects may also search an override table (e.g. 430) to determine if the individual having particular identity information (e.g. 432) has a priority (e.g. 434) not necessarily controlled by their role (e.g. 416).

Decision block 840 determines whether an identity of the caller was obtained in block 830. For example, in some aspects, there may not be an entry in an phone number table (e.g. 405) for the caller id information obtained in block 810. If no identity was obtained, process 730 moves from block 840 to block 850, which may transfer the call to an interactive voice response system (e.g. 112) or a human operator based hold queue (e.g. 114). After a connection is opened between one or more of the IVR system and the human operator, the IVR or human operator may then obtain the identity of the caller, which may then be written to the caller id datastore 111 in some aspects.

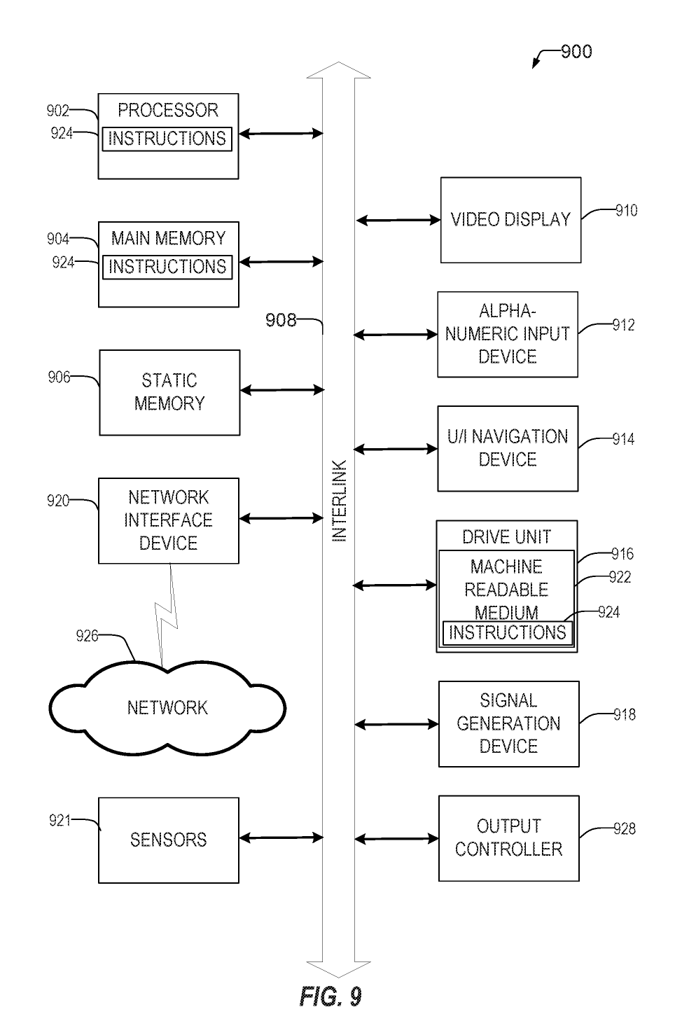

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. Machine 900 may implement, in whole or in part, the any one of the intelligent engine 102, and/or event aggregator 112. In various embodiments, machine 900 may perform one or more of the processes described above with respect to FIGS. 6 and/or 7 and/or 8. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 924 may further be transmitted or received over a communications network 926 using a transmission medium via the network interface device 920. The machine 900 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Example 1 is a system for routing calls over a calling network, comprising processing circuitry; hardware memory storing instructions that, when executed by the processing circuitry, control the system to perform operations comprising: receiving a call request message from a network; determining a geographic origin of the call request message; determining, by accessing a regional event datastore according to the geographic origin of the call request message, whether the geographic origin is experiencing a regional event, wherein the regional event datastore stores aggregated information indicating one or more events occurring within one or more corresponding geographic regions; determining a priority associated with the call request message based on one or more fields of the call request message; selecting a network for the call request message from a plurality of networks based on the priority and whether the origin is experiencing a regional event; and routing the call request message over the selected network.

In Example 2, the subject matter of Example 1 optionally includes wherein the determining of the identity of the caller comprises: routing the call request message to an interactive voice response system; and receiving an indication of the caller's identify from the interactive voice response system.

In Example 3, the subject matter of any one or more of Examples 1-2 optionally include wherein the determining of the identity of the caller comprises opening a connection between the caller and a human operator.

In Example 4, the subject matter of any one or more of Examples 1-3 optionally include the operations further comprising: designating a first calling network for calls from the geographic origin based on a determination that the geographic origin is experiencing the regional event; routing the call request message over the first calling network in response to the designation; and routing other calls with different origins over a different calling network in response to determining the geographic origin is experiencing a regional event.

In Example 5, the subject matter of Example 4 optionally includes the operations further comprising removing the designation of the first calling network for calls from the geographic origin in response to a determination that the regional event has ended.

In Example 6, the subject matter of Example 5 optionally includes the operations further comprising determining the regional event has ended by periodically fetching data from a portion of the regional event datastore associated with the geographic region.

In Example 7, the subject matter of any one or more of Examples 1-6 optionally include the operations further comprising downloading data from a web service and parsing the data to determine whether the origin is experiencing a regional event, and updating the regional event datastore based on the determination.

In Example 8, the subject matter of Example 7 optionally includes wherein the downloaded data indicates seismic activity at the origin, and the operations further comprising parsing the seismic activity data to determine whether the geographic origin is experiencing a seismic event, and updating the regional event datastore based on the determination.

In Example 9, the subject matter of Example 8 optionally includes wherein the seismic activity data indicates whether the geographic origin has experienced an earthquake in a previous predetermined time period, and further indicates the size of the earthquake on the Richter scale, the operations further comprising comparing the size of the earthquake on the Richter scale to a Richter scale threshold, and determining whether the origin is experiencing a regional event based on the comparison.

In Example 10, the subject matter of any one or more of Examples 7-9 optionally include wherein the downloaded data indicates weather activity at the origin, the operations further comprising parsing the weather activity data to determine whether the geographic origin is experiencing a weather event.

In Example 11, the subject matter of any one or more of Examples 7-10 optionally include wherein the downloaded data indicates wind speed at the origin, the operations further comprising determining the geographic origin is experiencing a regional event if the wind speed at the origin is above a wind speed threshold.

In Example 12, the subject matter of any one or more of Examples 1-11 optionally include the operations further comprising transmitting a message to a calling device of the caller, the message requesting coordinates for the geographic location.

In Example 13, the subject matter of any one or more of Examples 1-12 optionally include wherein the call request message includes phase two data, the operations further comprising determining the geographic location based on the phase two data.

In Example 14, the subject matter of any one or more of Examples 1-13 optionally include wherein the call request message is a Session Initiation Protocol (SIP) request message, and the SIP request message indicates the geographic origin.

Example 15 is a method for routing calls over a calling network, the method comprising: receiving a call request message from a network; determining a geographic origin of the call request message; determining, by accessing a regional event datastore according to the geographic origin of the call request message, whether the geographic origin is experiencing a regional event, wherein the regional event datastore stores aggregated information indicating one or more events occurring within one or more corresponding geographic regions; determining a priority associated with the call request message based on one or more fields of the call request message; selecting a network for the call request message from a plurality of networks based on the priority and whether the origin is experiencing a regional event; and routing the call request message over the selected network.

In Example 16, the subject matter of Example 15 optionally includes wherein the determining of the identity of the caller comprises: routing the call request message to an interactive voice response system; and receiving an indication of the caller's identify from the interactive voice response system.

In Example 17, the subject matter of any one or more of Examples 15-16 optionally include wherein the determining of the identity of the caller comprises opening a connection between the caller and a human operator.

In Example 18, the subject matter of any one or more of Examples 15-17 optionally include designating a first calling network for calls from the geographic origin based on a determination that the geographic origin is experiencing the regional event; routing the call request message over the first calling network in response to the designation; and routing other calls with different origins over a different calling network in response to determining the geographic origin is experiencing a regional event.

In Example 19, the subject matter of Example 18 optionally includes removing the designation of the first calling network for calls from the geographic origin in response to a determination that the regional event has ended.

In Example 20, the subject matter of Example 19 optionally includes determining the regional event has ended by periodically fetching data from a portion of the regional event datastore associated with the geographic region.

In Example 21, the subject matter of any one or more of Examples 15-20 optionally include downloading data from a web service and parsing the data to determine whether the origin is experiencing a regional event, and updating the regional event datastore based on the determination.

In Example 22, the subject matter of Example 21 optionally includes wherein the downloaded data indicates seismic activity at the origin, and the method further comprising parsing the seismic activity data to determine whether the geographic origin is experiencing a seismic event, and updating the regional event datastore based on the determination.

In Example 23, the subject matter of Example 22 optionally includes wherein the seismic activity data indicates whether the geographic origin has experienced an earthquake in a previous predetermined time period, and further indicates the size of the earthquake on the Richter scale, the method further comprising comparing the size of the earthquake on the Richter scale to a Richter scale threshold, and determining whether the origin is experiencing a regional event based on the comparison.

In Example 24, the subject matter of any one or more of Examples 21-23 optionally include wherein the downloaded data indicates weather activity at the origin, the method further comprising parsing the weather activity data to determine whether the geographic origin is experiencing a weather event.

In Example 25, the subject matter of any one or more of Examples 21-24 optionally include wherein the downloaded data indicates wind speed at the origin, the method further comprising determining the geographic origin is experiencing a regional event if the wind speed at the origin is above a wind speed threshold.

In Example 26, the subject matter of any one or more of Examples 15-25 optionally include transmitting a message to a calling device of the caller, the message requesting coordinates for the geographic location.

In Example 27, the subject matter of any one or more of Examples 15-26 optionally include wherein the call request message includes phase two data, and the method further comprises determining the geographic location based on the phase 2 data.

In Example 28, the subject matter of any one or more of Examples 15-27 optionally include wherein the call request message is a Session Initiation Protocol (SIP) request message, and the SIP request message indicates the geographic origin.

Example 29 is an apparatus for routing calls over a calling network, the apparatus comprising: means for receiving a call request message from a network; means for determining a geographic origin of the call request message; means for determining, by accessing a regional event datastore according to the geographic origin of the call request message, whether the geographic origin is experiencing a regional event, wherein the regional event datastore stores aggregated information indicating one or more events occurring within one or more corresponding geographic regions; means for determining a priority associated with the call request message based on one or more fields of the call request message; means for selecting a network for the call request message from a plurality of networks based on the priority and whether the origin is experiencing a regional event; and means for routing the call request message over the selected network.

In Example 30, the subject matter of Example 29 optionally includes wherein the determining of the identity of the caller comprises: means for routing the call request message to an interactive voice response system; and means for receiving an indication of the caller's identify from the interactive voice response system.

In Example 31, the subject matter of any one or more of Examples 29-30 optionally include wherein the means for determining the identity of the caller comprises means for opening a connection between the caller and a human operator.

In Example 32, the subject matter of any one or more of Examples 29-31 optionally include means for designating a first calling network for calls from the geographic origin based on a determination that the geographic origin is experiencing the regional event; means for routing the call request message over the first calling network in response to the designation; and means for routing other calls with different origins over a different calling network in response to determining the geographic origin is experiencing a regional event.

In Example 33, the subject matter of Example 32 optionally includes means for removing the designation of the first calling network for calls from the geographic origin in response to a determination that the regional event has ended.

In Example 34, the subject matter of Example 33 optionally includes means for determining the regional event has ended by periodically fetching data from a portion of the regional event datastore associated with the geographic region.

In Example 35, the subject matter of any one or more of Examples 29-34 optionally include means for downloading data from a web service and parsing the data to determine whether the origin is experiencing a regional event, and updating the regional event datastore based on the determination.

In Example 36, the subject matter of Example 35 optionally includes wherein the downloaded data indicates seismic activity at the origin, and the apparatus further comprising means for parsing the seismic activity data to determine whether the geographic origin is experiencing a seismic event, and means for updating the regional event datastore based on the determination.

In Example 37, the subject matter of Example 36 optionally includes wherein the seismic activity data indicates whether the geographic origin has experienced an earthquake in a previous predetermined time period, and further indicates the size of the earthquake on the Richter scale, the apparatus further comprising means for comparing the size of the earthquake on the Richter scale to a Richter scale threshold, and means for determining whether the origin is experiencing a regional event based on the comparison.

In Example 38, the subject matter of any one or more of Examples 35-37 optionally include wherein the downloaded data indicates weather activity at the origin, the apparatus further comprising means for parsing the weather activity data to determine whether the geographic origin is experiencing a weather event.

In Example 39, the subject matter of any one or more of Examples 35-38 optionally include wherein the downloaded data indicates wind speed at the origin, the apparatus further comprising means for determining the geographic origin is experiencing a regional event if the wind speed at the origin is above a wind speed threshold.

In Example 40, the subject matter of any one or more of Examples 29-39 optionally include means for transmitting a message to a calling device of the caller, the message requesting coordinates for the geographic location.

In Example 41, the subject matter of any one or more of Examples 29-40 optionally include wherein the call request message includes phase two data, the operations further comprising determining the geographic location based on the phase two data.

In Example 42, the subject matter of any one or more of Examples 29-41 optionally include wherein the call request message is a Session Initiation Protocol (SIP) request message, and the SIP request message indicates the geographic origin.

Example 43 is a non-transitory computer readable medium comprising instructions that when executed cause processing circuitry to perform operations for routing calls over a calling network, the operations comprising: receiving a call request message from a network, determining a geographic origin of the call request message; determining, by accessing a regional event datastore according to the geographic origin of the call request message, whether the geographic origin is experiencing a regional event, wherein the regional event datastore stores aggregated information indicating one or more events occurring within one or more corresponding geographic regions; determining a priority associated with the call request message based on one or more fields of the call request message; selecting a network for the call request message from a plurality of networks based on the priority and whether the origin is experiencing a regional event; and routing the call request message over the selected network.

In Example 44, the subject matter of Example 43 optionally includes wherein the determining of the identity of the caller comprises: routing the call request message to an interactive voice response system; and receiving an indication of the caller's identify from the interactive voice response system.

In Example 45, the subject matter of any one or more of Examples 43-44 optionally include wherein the determining of the identity of the caller comprises opening a connection between the caller and a human operator.

In Example 46, the subject matter of any one or more of Examples 43-45 optionally include designating a first calling network for calls from the geographic origin based on a determination that the geographic origin is experiencing the regional event; routing the call request message over the first calling network in response to the designation; and routing other calls with different origins over a different calling network in response to determining the geographic origin is experiencing a regional event.

In Example 47, the subject matter of Example 46 optionally includes removing the designation of the first calling network for calls from the geographic origin in response to a determination that the regional event has ended.

In Example 48, the subject matter of Example 47 optionally includes determining the regional event has ended by periodically fetching data from a portion of the regional event datastore associated with the geographic region.

In Example 49, the subject matter of any one or more of Examples 43-48 optionally include downloading data from a web service and parsing the data to determine whether the origin is experiencing a regional event, and updating the regional event datastore based on the determination.

In Example 50, the subject matter of Example 49 optionally includes wherein the downloaded data indicates seismic activity at the origin, and the operations further comprising parsing the seismic activity data to determine whether the geographic origin is experiencing a seismic event, and updating the regional event datastore based on the determination.

In Example 51, the subject matter of Example 50 optionally includes wherein the seismic activity data indicates whether the geographic origin has experienced an earthquake in a previous predetermined time period, and further indicates the size of the earthquake on the Richter scale, the operations further comprising comparing the size of the earthquake on the Richter scale to a Richter scale threshold, and determining whether the origin is experiencing a regional event based on the comparison.

In Example 52, the subject matter of any one or more of Examples 49-51 optionally include wherein the downloaded data indicates weather activity at the origin, the operations further comprising parsing the weather activity data to determine whether the geographic origin is experiencing a weather event.

In Example 53, the subject matter of any one or more of Examples 49-52 optionally include wherein the downloaded data indicates wind speed at the origin, the operations further comprising determining the geographic origin is experiencing a regional event if the wind speed at the origin is above a wind speed threshold.

In Example 54, the subject matter of any one or more of Examples 43-53 optionally include transmitting a message to a calling device of the caller, the message requesting coordinates for the geographic location.

In Example 55, the subject matter of any one or more of Examples 43-54 optionally include wherein the call request message includes phase two data, the operations further comprising determining the geographic location based on the phase two data.

In Example 56, the subject matter of any one or more of Examples 43-55 optionally include wherein the call request message is a Session Initiation Protocol (SIP) request message, and the SIP request message indicates the geographic origin.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

1. A system for routing calls over a calling network, comprising processing circuitry;
hardware memory storing instructions that, when executed by the processing circuitry, control the system to perform operations comprising:
receiving a call request message;
determining a geographic origin of the call request message;
determining, by accessing a regional event datastore according to the geographic origin of the call request message, whether the geographic origin is experiencing a regional event indicating a change in usage requirements in the region, wherein the regional event datastore stores aggregated information indicating one or more events occurring within one or more corresponding geographic regions;
determining a priority associated with the call request message based on one or more fields of the call request message;
selecting a network for the call request message from a plurality of networks based on the priority and whether the origin is experiencing a regional event; and
routing the call request message over the selected network.

2. The system of claim 1, wherein the priority is further determined based on an identity of the caller, the operations further comprising determining the identity of the caller by:
routing the call request message to an interactive voice response system; and
receiving an indication of the caller's identify from the interactive voice response system.

3. The system of claim 1, wherein the priority is further determined based on an identity of the caller, the operations further comprising determining the identity of the caller by opening a connection between the caller and a human operator, and receiving input indicating the identity of the caller.

4. The system of claim 1, the operations further comprising:
designating a first calling network for calls from the geographic origin based on a determination that the geographic origin is experiencing the regional event, wherein the selecting of the network selects the first calling network further based on the designation;
routing the call request message over the first calling network in response to the designation; and
routing other calls with different origins over a different calling network in response to determining the geographic origin is experiencing a regional event.

5. The system of claim 4, the operations further comprising removing the designation of the first calling network for calls from the geographic origin in response to a determination that the regional event has ended.

6. The system of claim 5, the operations further comprising determining the regional event has ended by periodically fetching data from a portion of the regional event datastore associated with the geographic region.

7. The system of claim 1, the operations further comprising downloading data from a web service and parsing the data to determine whether the origin is experiencing a regional event, and updating the regional event datastore based on the determination.

8. The system of claim 7, wherein the downloaded data indicates seismic activity at the origin, and the operations further comprising parsing the seismic activity data to determine whether the geographic origin is experiencing a seismic event, and updating the regional event datastore based on the determination.

9. The system of claim 8, wherein the seismic activity data indicates whether the geographic origin has experienced an earthquake in a previous predetermined time period, and further indicates the size of the earthquake on the Richter scale, the operations further comprising comparing the size of the earthquake on the Richter scale to a Richter scale threshold, and determining whether the origin is experiencing a regional event based on the comparison.

10. The system of claim 7, wherein the downloaded data indicates weather activity at the origin, the operations further comprising parsing the weather activity data to determine whether the geographic origin is experiencing a weather event

11. The system of claim 7, wherein the downloaded data indicates wind speed at the origin, the operations further comprising determining the geographic origin is experiencing a regional event if the wind speed at the origin is above a wind speed threshold.

12. The system of claim 1, the operations further comprising transmitting a message to a calling device of the caller, the message requesting coordinates for the geographic location.

13. The system of claim 1, wherein the call request message includes phase two data, the operations further comprising determining the geographic location based on the phase 2 data.

14. The system of claim 1, wherein the call request message is a Session Initiation Protocol (SIP) request message, and the SIP request message indicates the geographic origin.

15. A method for routing calls over a calling network, the method comprising:
receiving a call request message;
determining a geographic origin of the call request message;
determining, by accessing a regional event datastore according to the geographic origin of the call request message, whether the geographic origin is experiencing a regional event indicating a change in usage requirements in the region, wherein the regional event datastore stores aggregated information indicating one or more events occurring within one or more corresponding geographic regions;
determining a priority associated with the call request message based on one or more fields of the call request message;
selecting a network for the call request message from a plurality of networks based on the priority and whether the origin is experiencing a regional event; and
routing the call request message over the selected network.

16. The method of claim 15, further comprising downloading data from a web service and parsing the data to determine whether the origin is experiencing a regional event, and updating the regional event datastore based on the determination, wherein the downloaded data indicates seismic activity at the origin, and the method further comprises parsing the seismic activity data to determine whether the geographic origin is experiencing a seismic event, and updating the regional event datastore based on the determination.

17. The method of claim 16, wherein the seismic activity data indicates whether the geographic origin has experienced an earthquake in a previous predetermined time period, and further indicates the size of the earthquake on the Richter scale, the method further comprising comparing the size of the earthquake on the Richter scale to a Richter scale threshold, and determining whether the origin is experiencing a regional event based on the comparison.

18. An apparatus for routing calls over a calling network, the apparatus comprising:
means for receiving a call request message;
means for determining a geographic origin of the call request message;
means for determining, by accessing a regional event datastore according to the geographic origin of the call request message, whether the geographic origin is experiencing a regional event indicating a change in usage requirements in the region, wherein the regional event datastore stores aggregated information indicating one or more events occurring within one or more corresponding geographic regions;
means for determining a priority associated with the call request message based on one or more fields of the call request message;
means for selecting a network for the call request message from a plurality of networks based on the priority and whether the origin is experiencing a regional event; and
means for routing the call request message over the selected network.

19. The apparatus of claim 15, wherein the means for determining the priority of the call associated with the request message further comprises means for routing the call request message to an interactive voice response system; and
means for receiving an indication of the caller's identity from the interactive voice response system, wherein the means for determining the priority of the call associated with the request message is configured to determine the priority of the call based on the caller's identity.

20. The apparatus of claim 15, wherein the means for determining the priority of the call associated with the request message comprises means for opening a connection between the caller and a human operator, wherein the means for determining the priority of the call associated with the request message is configured to determine the priority of the call based on input received from the human operator.

21. (canceled)

22. The system of claim 1, wherein the regional event indicates the region is experiencing one or more of a power outage, major sporting event, seismic event or weather-based event.
